(19) United States
(12) Patent Application Publication
(10) Pub. No.: US 2009/0247062 A1
(43) Pub. Date: Oct. 1, 2009

(54) Oil smoke exhausting device

(76) Inventor: Hsiu-Yin Chen, Fengyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,455

(22) Filed: Feb. 23, 2009

(30) Foreign Application Priority Data
Mar. 31, 2008 (TW) 097111777

(51) Int. Cl. B08B 15/02

(52) U.S. Cl. 454/49

(57) ABSTRACT

An oil smoke exhausting device is provided with a body and a blower. The body has therebelow a first suction inlet and has a first exhaust outlet on its top surface. The blower has therebelow a second suction inlet and its transverse second exhaust outlet is mounted on a wall and communicates with the outdoor. An air duct is vertically disposed between and communicates with the first exhaust outlet of the body and the second suction inlet of the blower, thus capable of directly exhausting oil smoke from the indoor to the outdoor.

### BACKGROUND OF THE INVENTION

(a) Field of the Invention

The present invention relates to an oil smoke exhausting device, and, more particularly, to an oil smoke exhausting device that can directly exhaust oil smoke from the indoor to the outdoor.

(b) Description of the Prior Art

A blower is an air pump, and is a device that can cause air flow by pressure differences. In general, blowers can be classified into two categories: axial flow type and centrifugal type. Axial flow blowers are classified into four kinds: helical blowers, wind tunnel blowers, slotted blade axial flow blowers, and disk blowers. Among them, the air blown by an axial flow blower is parallel to its axis, and the disk for blade rotation is perpendicular to the axis. A centrifugal blower generates a pressure by means of centrifugal force to suck and exhaust air. Hence, air is parallel to the axis when it drawn into the blades, radially passing through the blades after it passes the fan blades, then exiting from the turbulence chamber around the edges of the blades and sent out along the tangential direction.

The exhaust efficiency is influenced by air volume, air speed and air pressure and the like. Air volume refers to the blown volume per unit time. Air speed refers to the speed of air flow. Pressure can be represented by three forms, that is, static pressure: a static pressure is generally considered as a pressure which exists when a fluid does not flow; dynamic pressure: a pressure is caused by fluid currents from its literal meaning; total pressure: a sum of a static pressure and a dynamic pressure. Accordingly, to obtain the good exhaust efficiency of an oil smoke exhausting device, the arrangement of the air duct between the blower and the body significantly influences the air volume, air speed and air pressure and the like.

The problems of conventional oil smoke exhausting devices are listed as below:

As illustrated in FIG. 4, provided is a first conventional oil smoke exhausting device 90. It can be seen from the figure that the body 901 of the oil smoke exhausting device 90 is disposed in the indoor section and its blower 902 for exhausting oil smoke is a centrifugal type blower and disposed in the outdoor section. For the purpose of connection of both the body and the blower, the air duct 903 must be connected to the body 901, extending upwardly and bending laterally, then extending in a transverse direction to the outdoor side. Afterwards, it bends downwardly and is connected to the blower 902. Oil smoke is blown off by means of the operation of the blower 902. However, the blower 902 draws unwanted oil smoke into the outdoor section. Due to a change in the angle of the bent air duct 903, it is easy for air to collide with the wall within the air duct 903. This causes a reduction in the air speed and a decrease in the air pressure such that the exhaust air volume is reduced. Therefore, the oil smoke exhaust efficiency is lowered.

As illustrated in FIG. 5, provided is a second conventional oil smoke exhausting device 91. It can be seen from the figure that the body 911 of the oil smoke exhausting device is disposed in the indoor section and its blower 912 for exhausting oil smoke is a centrifugal type blower and also disposed in the outdoor section. For the purpose of connection of both the body and the blower, the air duct 913 must be connected to the body 911, extending upwardly and bending laterally, then extending in a transverse direction to the outdoor side and being connected to the blower 912. Where it differs from the first conventional oil smoke exhausting device 90 is that the air duct 913 extends to the outdoor side and then is directly connected to the blower 912. The second conventional oil smoke exhausting device has one less bending section than the first conventional oil smoke exhausting device 90, but this still has an influence on the air speed and the air pressure as well as has a significant influence on the oil smoke exhaust efficiency.

As illustrated in FIG. 6, provided is a third conventional oil smoke exhausting device 92. Where it differs from the first and second conventional oil smoke exhausting device 90, 91 is that the casing of the blower 922 used is of axial flow type and the internal fan blades are of centrifugal type. Similarly, the body 921 is disposed in the indoor section and the blower 922 is disposed in the outdoor section. It can be seen from the figure that the air duct 923 also extends upwardly and bends laterally, then extending in a transverse direction to the outdoor side. There is still the same problem as the second conventional oil smoke exhausting device 91.

As illustrated in FIG. 7, provided is a fourth conventional oil smoke exhausting device 93. It can be seen from the figure that the body 931 of the oil smoke exhausting device 93 and the blower 932 both are disposed in the indoor section and the blower 932 is also a centrifugal type blower. For the purpose of connection of both the body and the blower, one end of the air duct 933 is connected to the body 931, and the air duct extends upwardly and bends laterally and then is transversely connected at the other end to the blower 932. An air duct 934 is further connected to the air exhaust outlet of the blower 932, extending upwardly and bending laterally to exit the outdoor side. The oil smoke exhausting device 93 is provided with two air ducts 933, 934 for exhausting oil smoke. Therefore, this remarkably influences reductions in the air speed and air pressure of the exhaust efficiency, and the exhaust air volume is relatively low.

As illustrated in FIG. 8, provided is a fifth conventional oil smoke exhausting device 94. It can be seen from the figure that the blower 942 is disposed in the body 941 and is a centrifugal type blower. An air duct is connected to the outlet of the blower 942 and extends diagonally upwardly from the body 941 to exit to the outdoor side. Where it differs from the foregoing conventional oil smoke exhausting devices is that the air duct 943 is inclinedly arranged, not extending upwardly then transversely disposed. However, there is still a bending section in this inclined arrangement, so the air speed and air pressure of the exhaust efficiency would be reduced and thus the exhaust air volume is reduced.

As illustrated in FIG. 9, provided is a sixth conventional oil smoke exhausting device 95. It can be seen from the figure that the blower 952 is also disposed in the body 951 and is a double fan and centrifugal type blower. However, for exhausting oil smoke to the outdoor side, an air duct 953 is connected to the outlet of the blower 952. The air duct 953 must still extend upwardly and bend laterally, then transversely disposed to the outdoor side. Therefore, the air speed and air pressure of the exhaust efficiency would be reduced and thus the exhaust air volume is reduced as same as the foregoing conventional oil smoke exhausting devices.

As concluded from the above description, no matter which form of the blower for exhausting oil smoke of a conventional oil smoke exhausting device is employed or no matter how different the blower is disposed with respect to the body, the air duct must have a bending section which generates turbulence during the exhausting process. This will directly influence air speed, air pressure and air volume of the exhaust efficiency. Therefore, how to solve the generation of turbulence in a conventional oil smoke exhausting device during the exhausting process and to improve the exhaust efficiency are the key points of the present invention.

### SUMMARY OF THE INVENTION

A primary objective of the present invention is to provide an oil smoke exhausting device to solve the above problems. The blower is directly disposed on a wall at the second exhaust outlet. The second suction inlet disposed below the blower is disposed with respect to the first exhaust outlet above the body. An air duct is further vertically disposed between said first exhaust outlet and said second suction inlet. By virtue of the vertical arrangement between said first exhaust outlet and said second suction inlet, the blower shows improved exhaust efficiency in the same condition, as compared to conventional oil smoke exhausting devices. That is, in the same condition, the oil smoke exhausting device according to the present invention can provide a relatively high air volume without the loss of air speed and air pressure due to the bending of the air duct and due to the reduction in turbulence during the exhausting process.

To achieve the foregoing objectives, the oil smoke exhausting device in accordance with the present invention includes:

A body, which is mounted on a wall and has therebelow at least one first suction inlet to allow the entry of oil smoke, said body having at least one first exhaust outlet on its top surface.

At least one blower, which is driven by a motor, mounted above said body and has a second suction inlet facing downward and corresponding to the position of the first exhaust outlet of said body, and has a transverse second exhaust outlet facing the wall on which said body is mounted to allow exhausting of oil smoke, said blower being fixedly disposed on said wall at the position of its second exhaust outlet and communicating with the outdoor;

An air duct, which is vertically disposed between said body and said blower in an appropriate length to communicate with both the body and the blower, one end of said air duct being mounted to the first exhaust outlet of said body and the other end being mounted to the second suction inlet of said blower.

Moreover, said blower is fixedly disposed at said second exhaust outlet with an adapter which is fixedly connected to said wall for positioning said blower.

### BRIEF DESCRIPTION OF THE DRAWINGS

FIG. 1 is a schematic view showing a two-dimensional structure of the present invention.

FIG. 2 is a view showing a three-dimensional structure of a blower and an adapter according to the present invention.

FIG. 3 is a schematic view showing oil smoke exhaust lines of the present invention as compared to the prior art.

FIG. 4 is a view showing a planar structure of a first conventional oil smoke exhausting device.

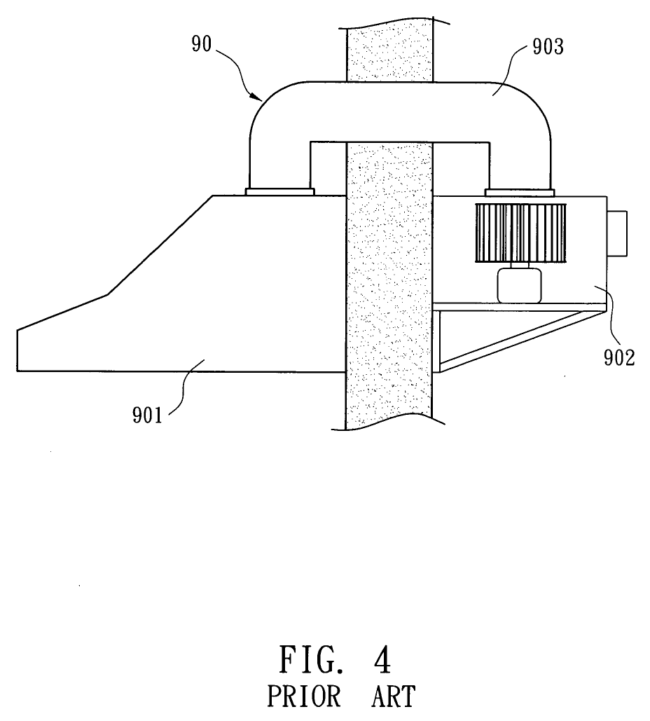

FIG. 5 is a view showing a planar structure of a second conventional oil smoke exhausting device.

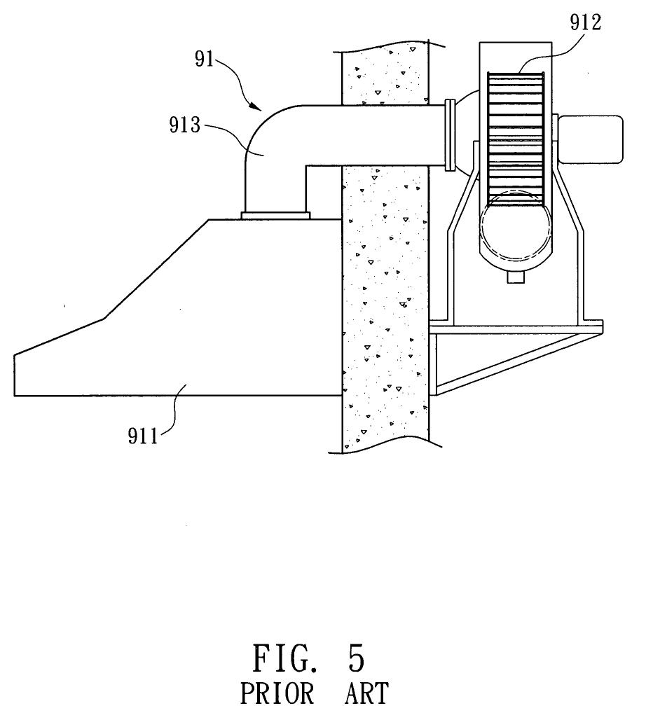

FIG. 6 is a view showing a planar structure of a third conventional oil smoke exhausting device.

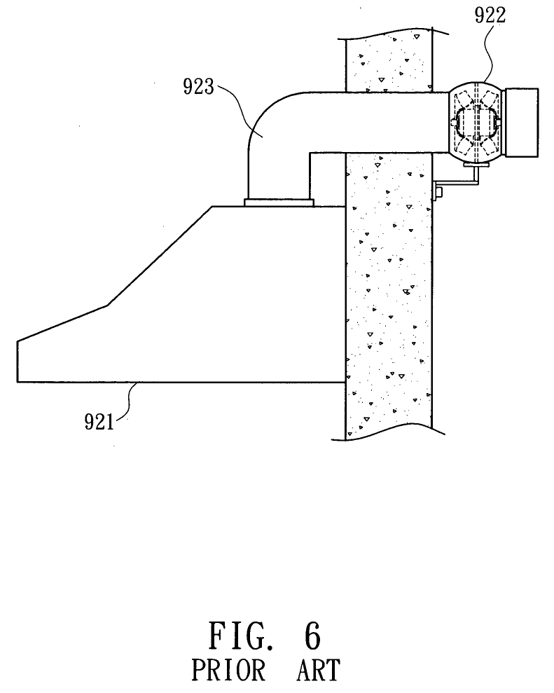

FIG. 7 is a view showing a planar structure of a fourth conventional oil smoke exhausting device.

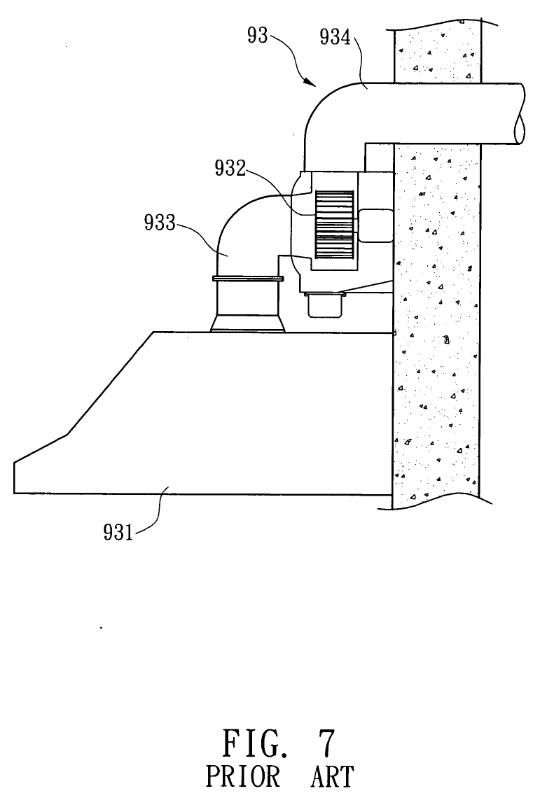

FIG. 8 is a view showing a planar structure of a fifth conventional oil smoke exhausting device.

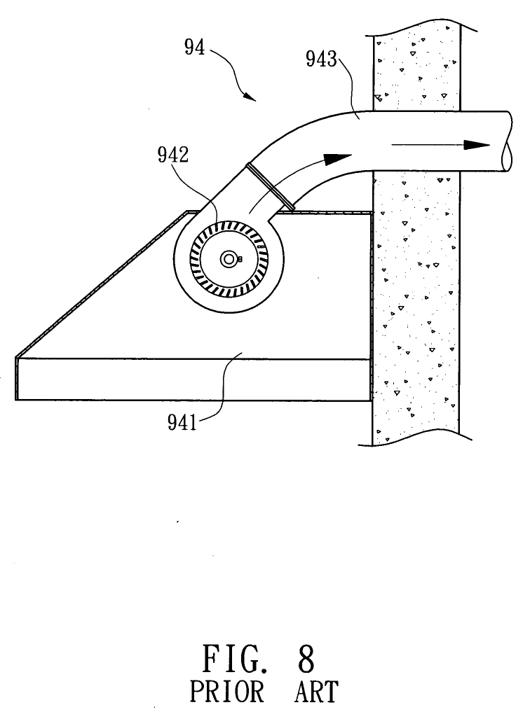

FIG. 9 is a view showing a planar structure of a sixth conventional oil smoke exhausting device.

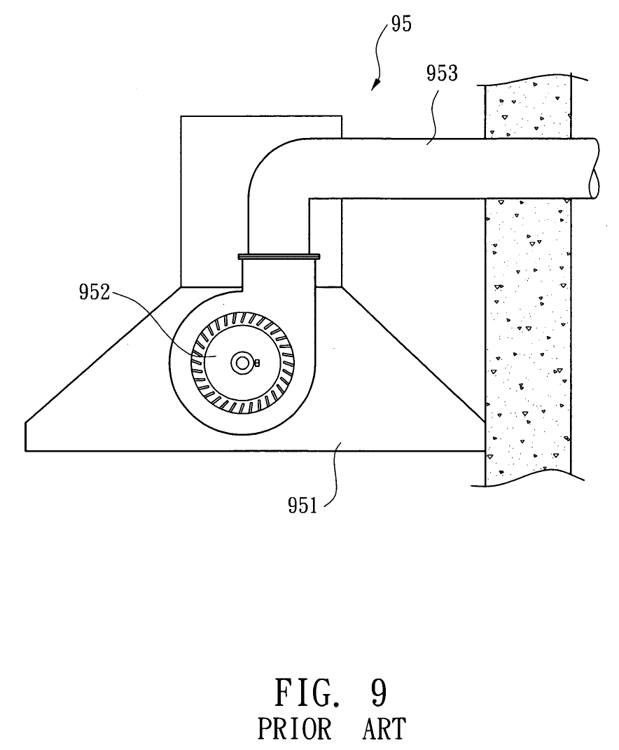

### DETAILED DESCRIPTION OF THE PREFERRED EMBODIMENTS

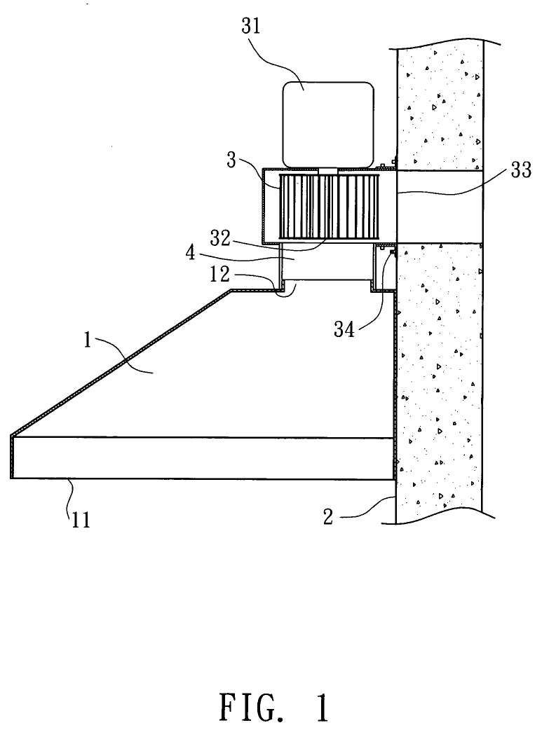

Referring to FIGS. 1 to 3, illustrated is a structure according to a selected embodiment of the present invention. This structure given is simply for purposes of illustration and is not limitative of the application of the invention.

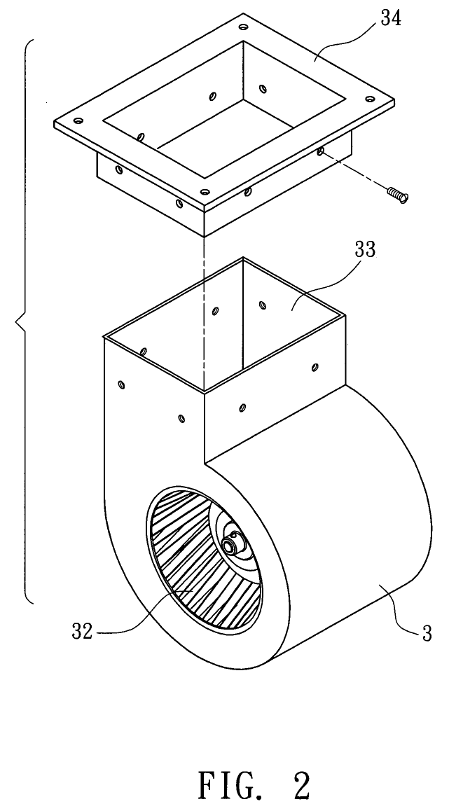

This embodiment provides an oil smoke exhausting device, as illustrated in FIGS. 1 and 2, including:

A body 1, which is mounted on a wall 2 and has therebelow at least one first suction inlet 11 to allow the entry of oil smoke, said body 1 having at least one first exhaust outlet 12 on its top surface.

At least one blower 3, which is driven by a motor 31, mounted above said body 1 and has a second suction inlet 32 facing downward and corresponding to the position of the first exhaust outlet 12 of said body 1, and has a transverse second exhaust outlet 33 facing the wall 2 on which said body 1 is mounted to allow exhausting of oil smoke, said blower 3 being fixedly disposed on said wall 2 at the position of its second exhaust outlet 33 and communicating with the outdoor, in this embodiment, said blower 3 being a centrifugal blower, and the included angle between said second suction inlet 32 and second exhaust outlet 33 of said blower 3 being 90 degrees;

An air duct 4, which is vertically disposed between said body 1 and said blower 3 in an appropriate length to communicate with both the body and the blower, one end of said air duct 4 being mounted to the first exhaust outlet 12 of said body 1 and the other end being mounted to the second suction inlet 32 of said blower 3.

In this embodiment, said blower 3 is fixedly disposed at said second exhaust outlet 33 with an adapter 34 which is fixedly connected to said wall 2 for positioning said blower 3.

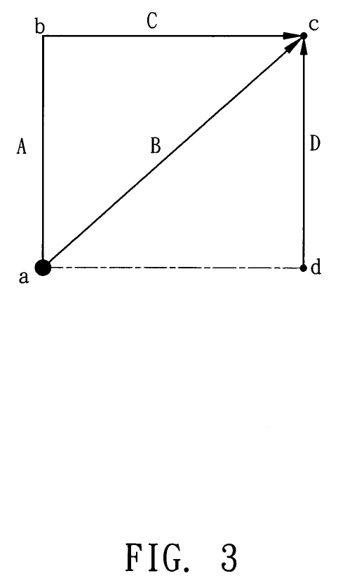

Referring to FIG. 3, there is shown a schematic view of oil smoke exhaust lines of the present invention as compared to conventional oil smoke exhausting devices. As is seen from this figure, point a represents an oil smoke inlet of a conventional oil smoke exhausting device, point b is where the air duct of a conventional oil smoke exhausting device is bent, and point c represents a same oil smoke exhaust outlet of each oil smoke exhausting device (defined as the second exhaust outlet 33 in the present invention) The length of line segment A between point a and point b is the distance the air duct of a conventional oil smoke exhausting device extends upwardly. The length of line segment C between point b and point c is the distance the air duct of a conventional oil smoke exhausting device extends in a transverse direction after it is bent. Alternatively, the length of line segment B between point a and point c is the distance the air duct of a conventional oil smoke exhausting device extends diagonally.

In the present invention, point d represents an oil smoke inlet of an oil smoke exhausting device according to the present invention (defined as the first suction inlet 11 in the present invention), and the length of line segment D between point c and point d is the distance the air duct of the present invention extends upwardly.

As described in the Description of the Prior Art, no matter which form of the blower for exhausting oil smoke of a conventional oil smoke exhausting device is employed or no matter how different the blower is disposed with respect to the body, the air duct must have a bending section to exhaust oil smoke from point a via point b to point c and then to the outdoor side, or from point a via line segment B diagonally to point c and then to the outdoor side. However, when fluid flows in an air duct, the more frequently the fluid collides with surfaces within the air duct, the greater influence on the fluid flow is. Accordingly, this will directly influence air speed, air pressure, air volume and the like of the exhaust efficiency. In comparison with line segment D of the present invention, the air duct is vertically disposed between said body 1 and said blower 3, thus reducing the influence on the air speed, air pressure and air volume of the oil smoke exhausting device. Oil smoke is sucked into said second suction inlet 32 and subsequently exhausted from the second exhaust outlet 33 of said blower 3 without the additional arrangement of an air duct or the bending of an air duct of a conventional oil smoke exhausting device. This can reduce the turbulence generated during the exhausting process such that the oil smoke exhausting device according to the present invention shows improved exhaust efficiency as compared to conventional oil smoke exhausting devices.

What is claimed is:

1. An oil smoke exhausting device including:
a body, which is mounted on a wall and has therebelow at least one first suction inlet to allow the entry of oil smoke, said body having at least one first exhaust outlet on its top surface;
at least one blower, which is driven by a motor, mounted above said body and has a second suction inlet facing downward and corresponding to the position of the first exhaust outlet of said body, and has a transverse second exhaust outlet facing the wall on which said body is mounted to allow exhausting of oil smoke, said blower being fixedly disposed on said wall at the position of its second exhaust outlet and communicating with the outdoor; and
an air duct, which is vertically disposed between said body and said blower in an appropriate length to communicate with both the body and the blower, one end of said air duct being mounted to the first exhaust outlet of said body and the other end being mounted to the second suction inlet of said blower.

2. The oil smoke exhausting device as claimed in claim 1, wherein the included angle between said second suction inlet and second exhaust outlet of said blower is 90 degrees.

3. The oil smoke exhausting device as claimed in claim 1, wherein said blower is fixedly disposed at said second exhaust outlet with an adapter which is fixedly connected to said wall for positioning said blower.
